(19) United States
(12) Patent Application Publication
(10) Pub. No.: US 2025/0111114 A1
(43) Pub. Date: Apr. 3, 2025

(54) METHOD FOR MODELING CROSS DIE COUPLING CAP IMPACT

(71) Applicant: TAIWAN SEMICONDUCTOR MANUFACTURING COMPANY, LTD., Hsinchu (TW)

(72) Inventors: Cheng-Tse CHOU, Hsinchu City (TW); King-Ho TAM, Hsinchu County (TW)

(73) Assignee: TAIWAN SEMICONDUCTOR MANUFACTURING COMPANY, LTD., Hsinchu (TW)

(21) Appl. No.: 18/480,372

(22) Filed: Oct. 3, 2023

(51) Int. Cl. G06F 30/3312; G06F 30/392; G06F 113/18; G06F 119/12

(52) U.S. Cl. CPC G06F 30/3312; G06F 30/392; G06F 2113/18; G06F 2119/12

(57) ABSTRACT

A method includes accessing a layout of a first die, wherein the first die is of a three-dimensional integrated circuit (3DIC) structure; generating a virtual design based on the layout of the first die, a first resistance and capacitance (RC) technology file (techfile) of the first die, and a second RC techfile of a second die, wherein the second die is of the 3DIC structure; performing a virtual coupling capacitance extraction on the virtual design to form a virtual coupling capacitance netlist; performing an static timing analysis on the first die with the virtual coupling capacitance netlist.

### BACKGROUND

Semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing are needed.

In the course of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs. Such scaling-down also produces a relatively high power dissipation value, which may be addressed by using low power dissipation devices such as complementary metal-oxide-semiconductor (CMOS) devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a schematic view of a three-dimensional (“3D”) integrated circuit (“IC”) structure, including multiple dies, in accordance with some embodiments of the present disclosure.

FIG. 1B illustrates a schematic diagram of a cross coupling model of a layout of a 3DIC structure as shown in FIG. 1A with an impedance mesh in accordance with some embodiments of the present disclosure, in which the cross coupling model including a single die, a virtual mirrored bump pattern, and a virtual metal fill pattern.

FIGS. 1C-1E illustrates top views of a virtual mirrored bump pattern, a virtual metal fill pattern, and a virtual ground plane pattern of cross coupling models in accordance with some embodiments of the present disclosure.

FIG. 1F illustrates a system and process for simulating frequency dependent effects of a die in a layout of a 3DIC structure with a coupling capacitance in accordance with some embodiments of the present disclosure.

FIG. 1G illustrates a block diagram of a system for analyzing a coupling resistance and capacitance (RC) extraction on a die of a layout of a 3DIC structure as shown in FIG. 1B in accordance with some embodiments of the present disclosure.

FIG. 1H illustrates a block diagram of a system for designing and analyzing an IC product in accordance with some embodiments of the present disclosure.

FIG. 1I illustrates a schematic diagram of a virtual coupling capacitance extraction (i.e., virtual coupling cap extraction) model generated by an RC extraction tool in accordance with some embodiments of the present disclosure.

FIG. 1J illustrates a schematic top view of an impedance mesh of a cross coupling model in accordance with some embodiments of the present disclosure.

FIG. 1K illustrates a perspective view of a layout including an exemplary model of metallization layers in some embodiments of the present disclosure.

FIG. 2A illustrates a schematic diagram of a cross coupling model of the layout of the 3DIC structure as shown in FIG. 1A in accordance with some embodiments of the present disclosure, in which the cross coupling model includes a single die, a virtual mirrored bump pattern, and a virtual metal fill pattern with an impedance mesh.

FIG. 2B illustrates a block diagram of a system for analyzing a virtual coupling capacitance extraction on a die of a layout of a 3DIC structure as shown in FIG. 2A in accordance with some embodiments of the present disclosure.

FIG. 3A illustrates a schematic view of a layout of a 3DIC structure, including multiple dies, in accordance with some embodiments of the present disclosure.

FIG. 3B illustrates a schematic diagram of a cross coupling model of the layout of the 3DIC structure as shown in FIG. 3A in accordance with some embodiments of the present disclosure, in which the cross coupling model includes a single die, a virtual mirrored bump pattern, and a virtual ground plane pattern with an impedance mesh.

FIG. 3C illustrates a block diagram of a system for analyzing a virtual coupling capacitance extraction on a die of a layout of a 3DIC structure as shown in FIG. 3B in accordance with some embodiments of the present disclosure.

FIG. 4A illustrates a schematic view of a layout of a 3DIC structure, including multiple dies, in accordance with some embodiments of the present disclosure.

FIG. 4B illustrates a schematic diagram of a cross coupling model of the layout of the 3DIC structure as shown in FIG. 4A in accordance with some embodiments of the present disclosure, in which the cross coupling model includes a single die, a virtual mirrored bump pattern, and a virtual metal fill pattern with an impedance mesh, and the die includes though silicon vias (TSV) therein.

FIG. 4C illustrates a block diagram of a system for analyzing a virtual coupling capacitance extraction on a die of a layout of a 3DIC structure as shown in FIG. 4B in accordance with some embodiments of the present disclosure.

FIG. 5A illustrates a schematic view of a layout of a 3DIC structure, including multiple dies, in accordance with some embodiments of the present disclosure.

FIG. 5B illustrates a schematic diagram of cross coupling models of the layout of the 3DIC structure as shown in FIG. 5A with virtual nets in accordance with some embodiments of the present disclosure.

FIG. 5C illustrates a block diagram of a system for designing and analyzing an IC product of a layout of a 3DIC structure as shown in FIG. 5A in accordance with some embodiments of the present disclosure.

FIG. 6A illustrates a schematic view of a semiconductor structure, including multiple dies and an integrated fan-out (InFO) structure between the dies, in accordance with some embodiments of the present disclosure.

FIG. 6B illustrates a schematic diagram of a cross coupling model of the semiconductor structure as shown in FIG. 6A in accordance with some embodiments of the present disclosure, in which the cross coupling model includes a single die, a virtual mirrored under bump metallurgy (UBM) pattern, and a virtual metal fill pattern with an impedance mesh.

FIG. 6C illustrates a block diagram of a system for analyzing a virtual coupling capacitance extraction on a die of a semiconductor structure as shown in FIG. 6B in accordance with some embodiments of the present disclosure.

FIG. 7A illustrates a schematic view of a semiconductor structure, including multiple dies and an InFO structure between the dies, in accordance with some embodiments of the present disclosure.

FIG. 7B illustrates a schematic diagram of a cross coupling model of the semiconductor structure as shown in FIG. 7A in accordance with some embodiments of the present disclosure, in which the cross coupling model includes a single die, a virtual mirrored UBM pattern, and a virtual metal fill pattern with an impedance mesh, and the die includes though silicon vias (TSV) therein.

FIG. 7C illustrates a block diagram of a system for analyzing a virtual virtual coupling capacitance extraction on a die of a semiconductor structure as shown in FIG. 7B in accordance with some embodiments of the present disclosure.

FIG. 8A illustrates a schematic view of a semiconductor structure, including multiple dies and an InFO structure between the dies, in accordance with some embodiments of the present disclosure.

FIG. 8B illustrates a schematic diagram of cross coupling models of the semiconductor structure as shown in FIG. 8A with virtual nets in accordance with some embodiments of the present disclosure.

FIG. 8C illustrates a block diagram of a system for designing and analyzing an IC product including an InFO structure as shown in FIG. 8A in accordance with some embodiments of the present disclosure.

FIG. 9A illustrates a top view of a virtual die having regions with different metal line densities in accordance with some embodiments of the present disclosure.

FIG. 9B illustrates a block diagram of a system for designing and analyzing an IC product in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, “around,” “about,” “approximately,” or “substantially” may generally mean within 20 percent, or within 10 percent, or within 5 percent of a given value or range. Numerical quantities given herein are approximate, meaning that the term “around,” “about,” “approximately,” or “substantially” can be inferred if not expressly stated. One skilled in the art will realize, however, that the values or ranges recited throughout the description are merely examples, and may be reduced or varied with the down-scaling of the integrated circuits.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

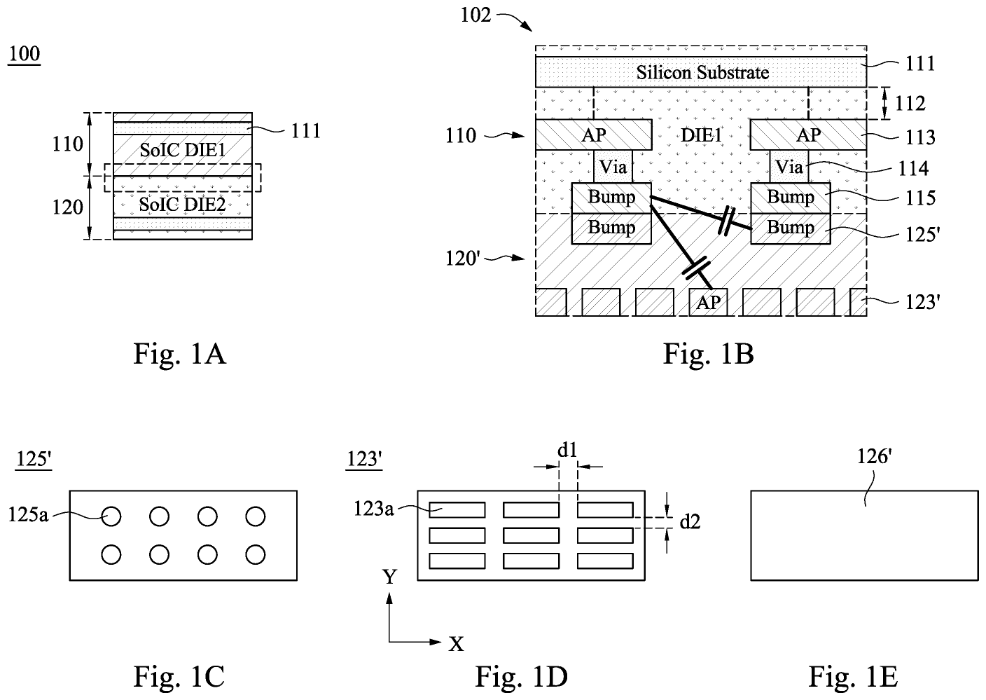

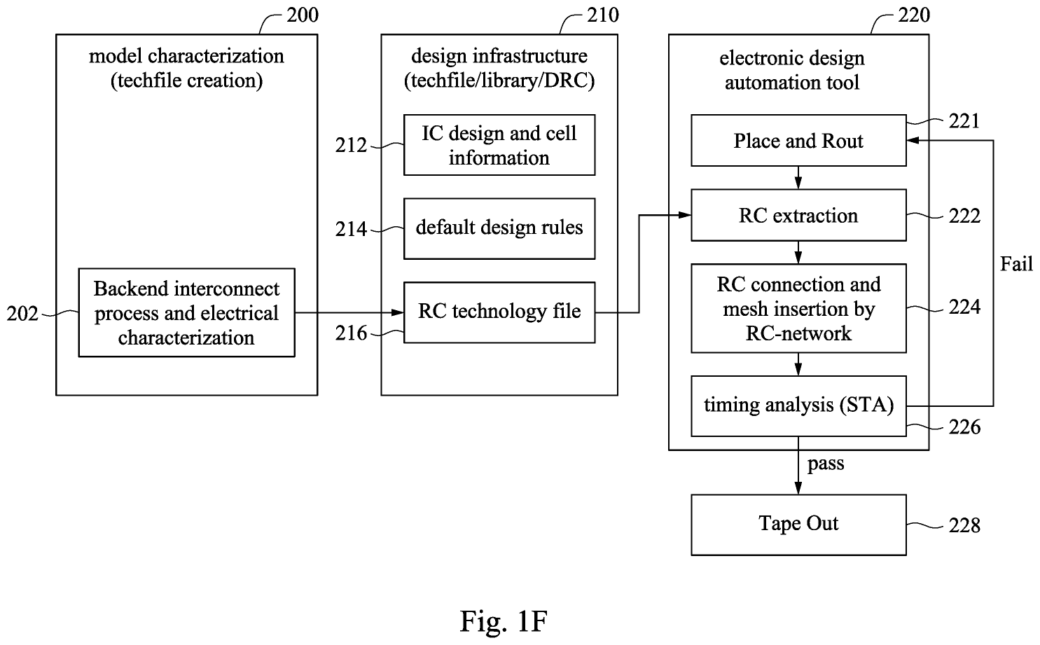

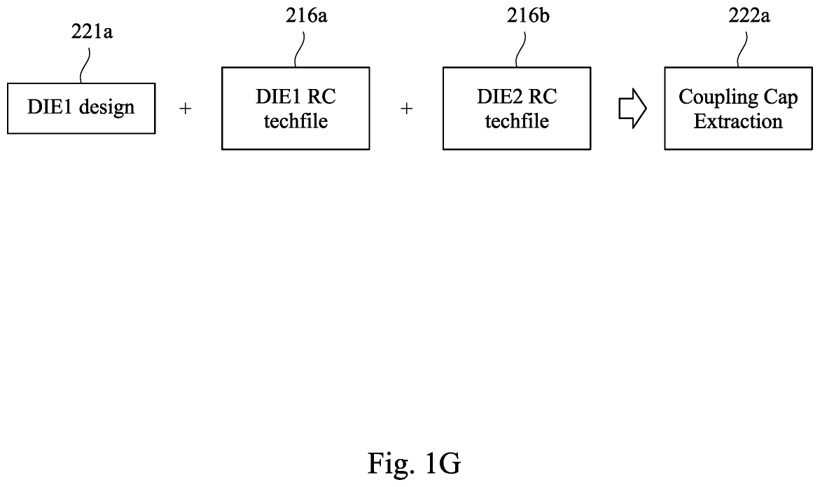

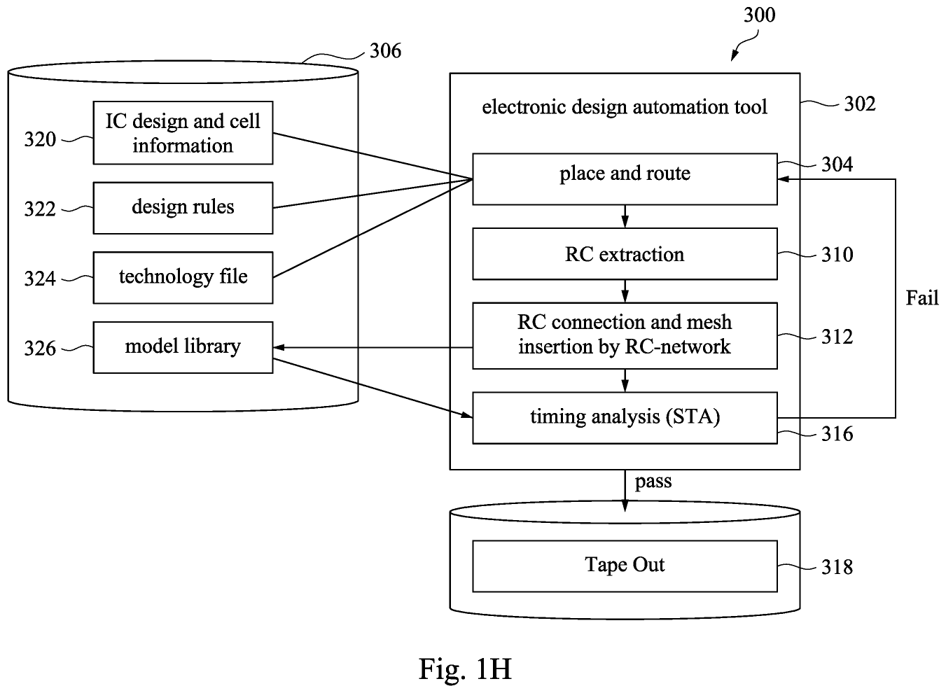

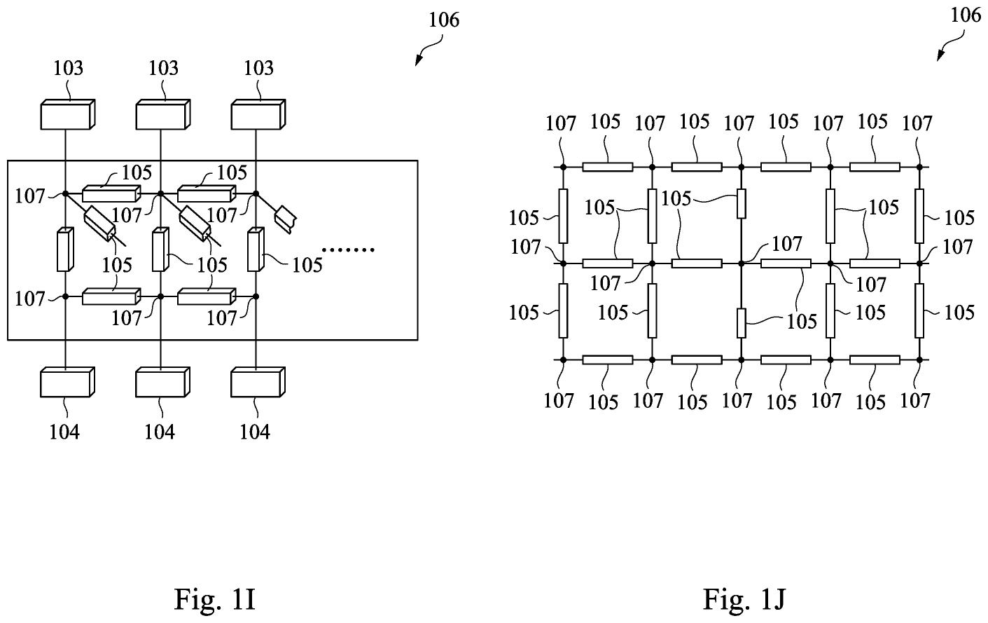

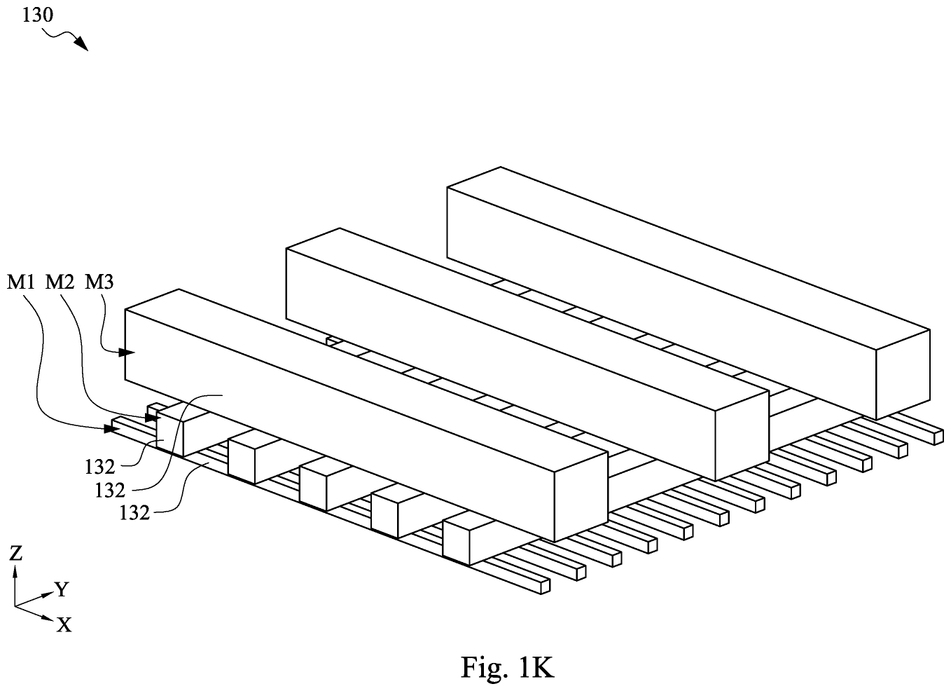

Reference is made to FIGS. 1A and 1B. FIG. 1A illustrates a schematic view of a layout of a three-dimensional (“3D”) integrated circuit (“IC”) structure 100, including multiple dies, in accordance with some embodiments of the present disclosure. FIG. 1B illustrates a schematic diagram of a cross coupling model 102 of the 3DIC structure as shown in FIG. 1A with an impedance mesh in accordance with some embodiments of the present disclosure, in which the cross coupling model 102 includes a single die 110, a virtual mirrored bump pattern 125′, and a virtual metal fill pattern 123′ with an impedance mesh. In some embodiments, the virtual metal fill pattern 123′ can be interchangeable referred to as a virtual metal routing, and the virtual mirrored bump pattern 125′, and the virtual metal fill pattern 123′ can be interchangeable referred an imaginary side (or a virtual side) of the cross coupling model 102. In some embodiments, the impedance mesh can be interchangeable referred to as a netlist.

Specifically, the layout of 3DIC structure 100 may include layout of dies 110 and 120. The die 110 may include substrate 111, metallization layers 112, metal pads/routings 113, vias 114, and bumps 115. In some embodiments, the metal pads/routings 113 can be made of a conductive material, such as aluminum, copper, tungsten, other suitable conductive materials, or combinations thereof. In some embodiments, the die 110 and/or 120 can be a system on integrated circuits (SoIC) die 110. In some embodiments, the metal pads/routings 113 can be made of a conductive material, such as aluminum, copper, tungsten, other suitable conductive materials, or combinations thereof. The cross coupling capacitance in a 3DIC arises due to the electromagnetic field interactions between different dies (e.g., dies 110 and 120). This phenomenon occurs when two or more dies are placed close together, resulting in an overlap of their respective electric fields. When there's a change in voltage in one die, due to signal transmission for example, it induces an electric field around it. If another die is in proximity, this changing electric field can induce a voltage change in that die as well, even if no direct electrical connection exists between the dies. This capacitance can affect the signal integrity, power consumption, and timing performance of the 3DIC structure 100, as it may introduce unintended signal interference or noise.

In general, a coupling capacitance extraction (i.e., coupling cap extraction or cross-die coupling extraction) in a 3DIC structure 100 is performed once the designs (i.e., layouts) of both dies (e.g., dies 110 and 120) are completed. This approach, however, imposes a waiting period on one die until the design of the other is finalized. This can create a synchronization bottleneck in the overall design flow of the 3DIC structure 100, delaying the progression of the design and/or fabrication of the 3DIC structure 100. Moreover, in the context of the 3DIC structure 100 where multiple dies are integrated into a single device, this wait can introduce inflexibility. Each die within the 3DIC is designed by a separate design team or, in some cases, a different company. The need to wait for the completion of other die designs before proceeding with the coupling capacitance extraction can thus create scheduling challenges and logistical difficulties. This lack of flexibility could lead to delays in the overall design and production process, presenting significant challenges in the integration of multiple dies within a single 3DIC device. Therefore, it is desirable to devise a design strategy that allows for the independent and flexible design of each die, without the need to wait for the completion of other dies before proceeding with the extraction of coupling capacitance. Such a strategy would allow for a more efficient, streamlined, and agile design process, enhancing the overall productivity and reducing the time-to-market for 3DIC devices.

In some embodiments, requiring the design for the die 120 to perform coupling capacitance extraction may introduce additional complexity, including the design for the die 120 deals with a more complex system, which can increase the time required for the extraction process and potentially lead to higher computational requirements. If the design of the die 120 is not readily available, this requirement could significantly slow down the extraction process and introduce additional costs. In addition, the extracted coupling capacitance becomes dependent on the characteristics of the die 120. If the design of the die 120 changes, the extraction process may need to be repeated, adding to the time and effort required.

In order to tackle the potential issues that arise from needing the design for the die 120 to perform virtual coupling capacitance extraction, the user may only need to provide the design for the die 110, such that the complexity and the dependence on the die 120 can be reduced, which in turn mitigates the need to have complete design details of the die 120, that can help save time and effort and reduces the chance of errors that might be introduced by a complex design of the die 120. In addition, the RC extraction tool 310 (see FIG. 1H) can create a virtual design 120′ (e.g., virtual mirrored bump pattern 125′ and/or virtual metal fill pattern 123′) for extraction purposes, thereby eliminating the need to receive the actual design of the die 120. In some embodiments, the virtual design 120′ can be generated based on predefined or user-inputted parameters, reducing the complexity of the extraction process and providing a more flexible and adaptable solution. Furthermore, by attaching the coupling capacitance to a virtual signal node resulted from the virtual design 120′, it can abstract away the specific details of the die 120, which in turn reduces the extraction process's dependence on the actual characteristics of the die 120, enabling more flexible and adaptable extraction results. Subsequently, the static timing analysis (STA) tool can annotate the virtual coupling capacitance by the virtual signal node for a signal integrity (SI) analysis, which in turn allows for abstracting away the need to have design details of the die 120, while still allowing for accurate SI analysis. Therefore, the consideration of cross-die coupling capacitance can be incorporated at the chiplet design phase, rather than postponing it until the integration stage.

The signal integrity analysis is a set of measures used to ensure that digital or analog signals are transmitted effectively across a circuit without losing their integrity. The signal integrity analysis can be used to assess various factors that could affect the quality and reliability of signals. These factors include noise, distortion, crosstalk, and signal loss, among others. In some embodiments, signal integrity issues can lead to data errors, slow data rates, and system instability. The signal integrity analysis can be used to predict and mitigate these potential issues, ensuring that the circuit performs as designed. The static timing analysis is one of the tools used in the signal integrity analysis to verify the timing performance of a digital circuit. It can check all possible paths for timing violations under worst-case conditions to ensure that the circuit will operate correctly under these circumstances. The STA may provide an understanding of the delays in a circuit, enabling designers to verify the design's timing under different scenarios, such as variations in process, voltage, and temperature (PVT variations). In addition, the STA can help in ensuring that data signals in digital circuits arrive at their intended destinations within an appropriate time window (i.e., meeting setup and hold times). This analysis can avoid issues such as setup time violation or hold time violation, which can lead to failures in the functioning of the digital circuit.

As shown in FIG. 1B, the real design (e.g., designed layout of die 110) and the virtual design 120′ each is required to have at least one bump (e.g., bump 115, virtual mirrored bump pattern 125′) and at least one top routing layer (e.g., metal pad/routing 113, virtual metal fill pattern 123′). In some embodiments, the user can consider including more routing layers to build a more accurate cross-die coupling capacitance model. This can help alleviate the potential accuracy loss that may arise due to the use of a virtual design 120′ for the die 120, allowing for more precise extraction results. In some embodiments, the real design of the die 110 can be interchangeable referred a real layout or a layout design of the die 110.

Reference is made to FIGS. 1C-1E. FIGS. 1C-1E illustrates top views of a virtual mirrored bump pattern, a virtual metal fill pattern, and a virtual ground plane pattern of virtual designs in cross coupling models in accordance with some embodiments of the present disclosure. As shown in FIG. 1C, the virtual mirrored bump pattern 125′, for instance, can comprise multiple circular top view profiles 125a. In some embodiments, the circular top view profile 125a may align with the configuration of bumps and their rounded or spherical forms. Specifically, the circular top view profile, mirrored based on the input design of the die 110, may act as representations for the bump structures of the die 120.

As shown in FIG. 1D, the virtual metal fill pattern 123′, for instance, can comprise multiple rectangular top view profiles 123a. In some embodiments, the rectangular top view profile 123a may align with the linear and/or grid-like structure of metal routes on an integrated circuit. Specifically, the rectangular top view profile 123a can serve as an abstraction for the metal fill design in the die 120. This approach of using simplified geometric representations (e.g., circular top view profile 125a for the virtual mirrored bump pattern 125′ and rectangular top view profile 123a for the virtual metal fill pattern 123′) in the virtual design 120′ allows for efficient coupling capacitance extraction while maintaining the simplicity and manageability of the process.

In some embodiments, in the design of a virtual metal fill pattern 123′ with multiple rectangular top-view profiles 123a, the distance d1 (or the pitch) in the X direction between adjacent top-view profiles can adopt a first minimum distance allowable under the design rules of die 120, and the distance d2 (or the pitch) in the Y direction between adjacent top-view profiles can adopt a second minimum distance allowable under the design rules of die 120. This minimum distances are parameters established in the design rule of the integrated circuit (IC), which stipulates the smallest allowable separation between two adjacent metal fill patterns. This is set to prevent undesirable effects such as short-circuiting or excessive electromagnetic interference which could degrade the performance of the IC. By using these minimum distances as the distances d1 and d2 in the design of the virtual metal fill pattern 123′, it may ensure that the model maintains the highest density of fills, which can mimic a worst-case scenario for coupling capacitance extraction. Moreover, this method can enhance the flexibility of the design process, as it doesn't rely on the specific details of the die 120, which in turn allows the die in a 3DIC structure 100 to more flexibly complete its own design, without waiting for the completion of other dies' designs, thus facilitating the integration of multiple dies in the 3DIC structure 100. In some embodiments, the distance d2 is different than the distance d1. In some embodiments, the distance d2 is substantially the same as the distance d1.

As shown in FIG. 1E, when the die 110 is bonded to the die 120 from a back side of the die 120, the process of modeling the virtual metal fill pattern 123′ can be simplified significantly. In this case, rather than generating multiple rectangular top view profiles for the virtual metal fill pattern 123′, the entirety of the back side of the die 120 can be represented by a complete ground plane 126′ without any split regions. This single, continuous ground plane effectively serves as a conductive layer.

Reference is made to FIGS. 1F-1H. FIG. 1F illustrates a system and process for simulating frequency dependent effects of the die 110 in a 3DIC structure 100 with a coupling capacitance in accordance with some embodiments of the present disclosure. FIG. 1G illustrates a block diagram of a system for analyzing a coupling capacitance resistance and capacitance (RC) extraction on the die 110 of the 3DIC structure 100 as shown in FIG. 1B in accordance with some embodiments of the present disclosure. FIG. 1H illustrates a block diagram of a system for designing and analyzing an IC product in accordance with some embodiments of the present disclosure.

Specifically, steps performed for model characterization (techfile creation) 200 and the design infrastructure (techfile/library and design rule check) 210 can be provided. At block 202, a backend interconnect process and electrical characterization is performed, and a RC model of a virtual design 120′ of the die 120 and a top routing layer in the die 110 can be characterized. Thus, the model can account for the active device layers and BEOL interconnect layers of the dies 110. This includes RC extraction, to compute RC values to be used in the circuit model to represent the coupling capacitance between the dies 110 and 120. At block 212, the IC design and cell information of the die 110 can be stored in a tangible storage medium for use in modeling and fabricating an IC. At block 214, a set of default design rules 214 can be provided for use by the place and route tool. At block 216, RC technology files including the definition of the material and geometry relationships for the technology node being used in the die 110 and/or 120 and the material and geometry relationships for the virtual design 120′ of the die 120 can be provided based on a characterization model from the block 202. This file may be in the form of the circuit elements. This RC technology file may be included as part of the original RC technology file and used during the block 202. In some embodiments, technology file can be abbreviated as techfile, and thus the technology file can be interchangeable referred to as techfile.

Subsequently, steps performed the design and fabrication process 220 including the virtual design 120′ of the die 120 can be provided through an electronic design automation (EDA) tool 302 (see FIG. 1H). At block 221, the place and route tool 304 (see FIG. 1H) can determine the locations of cells and the routing of conductive lines and vias to form a preliminary layout. At block 222, a RC extraction (RCX) can be performed for an IC design. For purpose of RC extraction, the machine implemented RC extraction tool 310 (FIG. 1H) can analyze the metal pads/routings 113, the vias 114, and the bumps 115 (modeled by RC nodes 103 as shown in FIG. 1I), and the virtual metal fill pattern 123′ and the virtual mirrored bump pattern 125′ (modeled by virtual RC nodes 104 as shown in FIG. 1I). The cross coupling model 102 (see FIG. 1B) can assume respective capacitive elements (or capacitors) 105 between the RC nodes 103 and 104. The RC extraction tool 310 outputs data representing a plurality of respective RC nodes 103 and 104 to a RC-network 312 in design library (e.g., design library 306 as shown in FIG. 1H). In some embodiments, the RC node 103 and/or 104 can be interchangeable referred to as a virtual signal node.

Referring again to FIG. 1F, at block 224, RC connection and mesh insertion can be performed by RC-network. Specifically, a mesh model 106 (FIG. 1I) of the cross coupling capacitance between the dies 110 and 120 can be generated having a plurality of mesh nodes 107. Each of the mesh nodes 107 is connected to adjacent ones of the plurality of mesh nodes 107. In some embodiments, the mesh nodes 107 can lie along a rectangular grid having orthogonal major axes X, Y and Z directions. Then a set of inputs to a timing analysis tool is formed from the cross coupling model 102 and the mesh model 106. The plurality of RC nodes 103 and 104 (see FIG. 1I) can be connected to ones of the plurality of mesh nodes 107 (FIGS. 1I and 1J) of the mesh model 106. The set of inputs is stored in a persistent, model library 326 (FIG. 1H). At block 226, a timing analysis including the cross coupling between the die 110 and the virtual design 120′ of the die 120 can be performed using a machine implemented a timing analysis tool 316 (see FIG. 1H) and the set of inputs, so as to simulate capacitive couplings between the RC nodes 103 and 104. At block 228, the timing analysis is performed on both the design of die 110, along with the virtual design 120′ of die 120. If the results of this analysis confirm that the combined design satisfies to a predetermined timing specification, the die 110 can be moved to tape-out. This satisfaction of the timing specification can indicate that the design of the die 110 can met criteria, and the readiness for the fabrication can be referred to as achieving “sign-off status.” In some embodiments, the mesh model including, such as the virtual mirrored bump pattern 125′ and the virtual metal fill pattern 123′, can serve as a virtual attacker in STA for SI analysis. On the other hand, if the results of the analysis do not satisfy the predetermined timing specification, the step will go back to block 221.

Reference is made to FIG. 1G. The virtual coupling capacitance extraction in the 3DIC structure 100 can be summarized by using the design of die 110, the RC techfile of die 110, and the RC techfile of die 120. In some embodiments, the design of the die 110 can be derived from the block 221a corresponding to the block 221 (see FIG. 1F), the RC techfile of the die 110 can be derived from the block 216a corresponding to the block 216 (see FIG. 1F), the RC techfile of the die 120 can be derived from the block 216b corresponding to the block 216 (see FIG. 1F), and the virtual coupling capacitance extraction in the 3DIC structure 100 can be derived from the block 222a corresponding to the block 222 (see FIG. 1F). Specifically, the design of the die 110 represents the specific structure, geometry, and characteristics of die 110. It forms the basis of the analysis for modeling the behavior of the die 110. The RC techfile of the die 110 may include detailed information about the resistive and capacitive properties of the interconnects and active device layers within the die 110. By RC extraction, we can know how signals will propagate within the die 110. The RC techfile of the die 120 may include detailed information about the die 120. This techfile, however, characterizes a virtual design 120′ and includes electrical parameters of process to compute the coupling capacitance between dies 110 and 120. The design of die 110, the RC techfile of die 110, and the RC techfile of die 120 can form a set of inputs allowing the system to simulate, analyze, and characterize the coupling capacitance between the dies 110 and 120 within the 3DIC structure 100. The information is used to generate a model of the interaction between the dies 110 and 120, including the effects of capacitance, which can then be used in further analysis and fabrication processes.

Reference is made to FIG. 1H. A system 300 can includes an electronic design automation (EDA) tool 302, which may include a place and route tool 304. The EDA tool 302 is a computer formed by retrieving stored program instructions from the design library 306 and executing the instructions on a general purpose processor (not shown). Examples of the design library 306 include, but are not limited to, read only memories (“ROMs”), random access memories (“RAMs”), flash memories, or the like. The design library 306 can be configured to store data generated by the place and route tool 304. The place and route tool 304 can be capable of receiving an identification of a plurality of cells to be included in an integrated circuit (“IC”) or interposer layout, including an IC design and cell information 320 of pairs of cells within the plurality of cells to be connected to each other. The place and route tool 304 may be equipped with a set of default design rules 322 and technology file 324, such that the backend interconnect process and electrical characterization 202, the IC design and cell information 212, the default design rules 214, RC technology file 216 developed by the process of the model characterization 200 and the design infrastructure 210 (shown in FIG. 1F) may provide parameters for a cross coupling between the die 110 and the virtual design 120′ of the die 120.

The EDA tool 302 can include an RC extraction tool 310 (FIG. 1H), as well as the timing analysis tool 316. The RC extraction tool 310 can be configured to perform RC timing analysis of the circuit patterns of the cross coupling between the die 110 and the virtual design 120′ of the die 120, such that the RC timing analysis is performed based on the layout of the metal pad/routing 113 (see FIG. 1B), the bump 115 (see FIG. 1B), the virtual metal fill pattern 123′ (see FIG. 1B), and the virtual mirrored bump pattern 125′ (see FIG. 1B), using the cross coupling model 102 (see FIG. 1B). In some embodiments, the RC extraction output file is in Standard Parasitic Format (SPF). In other embodiments, the RC extraction output file is in another format, such as Detailed Standard Parasitic Format (DSPF), Reduced Standard Parasitic Format (RSPF), Standard Parasitic Exchange Format (SPEF), or Synopsys Binary Parasitic Format (SBPF).

The EDA tool 302 can include a RC connection and mesh insertion by RC-network 312. The RC connection and mesh insertion by RC-network 312 can accept as output file of the RC extraction engine 310. From this file, the location of the RC nodes is determined. The mesh model 106 (see FIG. 1I) of the cross coupling capacitance can be generated, and combined with the RC node model output by the RC extraction engine. The combined model is then output in the same format as the RC extraction engine (or the same format used by the timing analysis tool 316). The timing analysis tool 316 (or STA simulator) can receive the combined model and performs a simulation, which can account for the characteristics of the cross coupling between the die 110 and the virtual design 120′ of the die 120. If the timing analysis result confirms that the design satisfies to a predetermined timing specification, the die 110 can be moved to tape-out 318. On the other hand, if the timing analysis result does not satisfy the predetermined timing specification, the timing analysis tool 316 will forward the work to the place and route tool 304 for execution.

Reference is made to FIGS. 1I and 1J. FIG. 1I illustrates a schematic diagram of a virtual coupling capacitance extraction model generated by an RC extraction tool 310 (FIG. 1H) in accordance with some embodiments of the present disclosure. FIG. 1J illustrates a schematic plane view of an impedance mesh of a cross coupling model 102 in accordance with some embodiments of the present disclosure. As shown in FIGS. 1I and 1J, the cross coupling model 102 and the mesh model 106 can be combined by joining the capacitive elements 105 of the cross coupling model 102 to selected the mesh nodes 107 in the mesh model 106 of the cross coupling capacitance. FIG. 1I further shows an example in which each of the RC nodes 103 can have a respective corresponding mesh node 107 of the mesh model 106 directly underlying the RC node 103, and each of the RC nodes 104 can have a respective corresponding mesh node 107 of the mesh model 106 directly above the RC node 104. Thus, there is a one-to-one correspondence between the RC nodes 103, 104 and the mesh nodes 107 on the front and back faces of the mesh model 106. The process of generating the mesh model 106 may include generating a respective mesh node 107 having the same in-plane (X-Y) coordinates as, and directly underlying, each respective RC node 103 or 104. The joining can be performed by way of a netlist. Thus, the netlist entries for RC extraction nodes corresponding to capacitive elements 105 can be modified to be connected to mesh nodes 107 of the mesh model 106. In some embodiments, the mesh model 106 can be interchangeable referred to as a netlist.

Reference is made to FIG. 1K. FIG. 1K illustrates a perspective view of a layout 130 including an exemplary model of metallization layers in some embodiments of the present disclosure. Specifically, the design and layout 130 of the die 100 may include multiple metallization layers (e.g., metallization layers M1 to M6). The metallization layers M1 to M3, each with specific orientations, widths, spacings, and connections between metal lines 132. In some embodiments, the design and layout 130 of the die 100 may include more metallization layers or fewer metallization layers than the layout shown in FIG. 1K. If timing analysis (see FIGS. 1A-1J) confirms that the die 110, including a virtual design 120′ of die 120, can meet the predetermined timing specifications, then the layout 130 of the die 110 can be fabricated as described. If the specifications are not met, modifications are required. For example, these changes will involve adjusting the density of metal layers in the metallization layers M1 to M3, specifically targeting those close to metal pads/routings 113 (e.g., modifying the higher metallization layers M3 without altering the lower layers M1). These adjustments could mean lowering the density of the metallization layers to ensure that the design satisfies the timing requirements, providing a path to successful fabrication. Therefore, the design of the metallization layers within the die 110 is design to meet specific timing specifications. If these are not met, adjustments are made to specific layers to ensure the die 110 can be successfully fabricated.

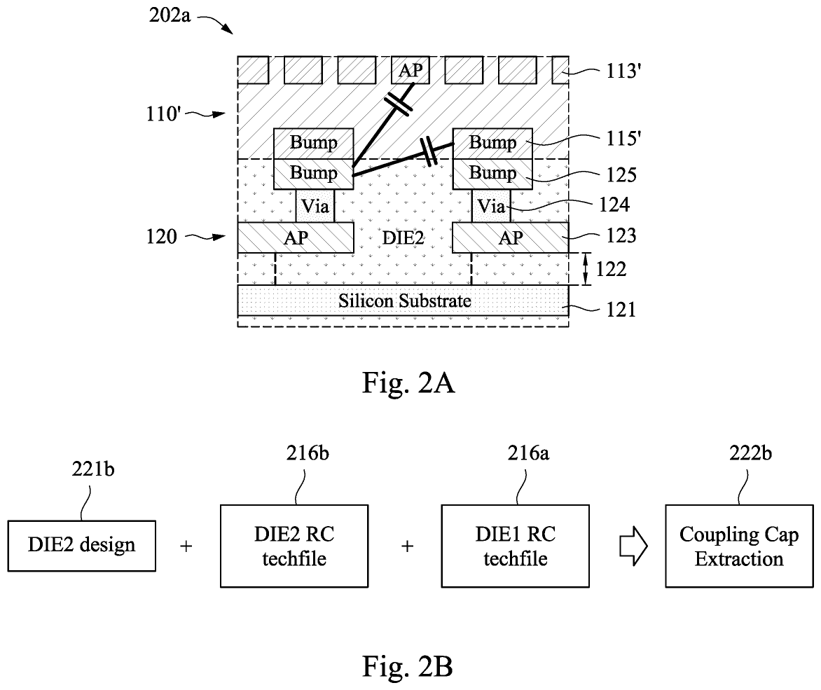

Reference is made to FIGS. 2A and 2B. FIG. 2A illustrates a schematic diagram of a cross coupling model 202a of the 3DIC structure 100 as shown in FIG. 1A in accordance with some embodiments of the present disclosure, in which the cross coupling model includes a single die 120, a virtual mirrored bump pattern 115′, and a virtual metal fill pattern 113′ with an impedance mesh. FIG. 2B illustrates a block diagram of a system for analyzing a virtual coupling capacitance extraction on a die of a 3DIC structure as shown in FIG. 2A in accordance with some embodiments of the present disclosure. In some embodiments, the design process for die 120 can be executed in the same manner as the design process for die 110. This means that whether a user is focusing on designing die 120 or die 110, the approach, methodology, and tools utilized can be the same. The details specific to each die, such as metallization layers, interconnects, or other design parameters, would be handled within the design process. The procedures, software, and protocols used to design one die can be directly applied to the other. This can streamline the design process, making it more efficient and potentially reducing errors, as the same proven techniques and strategies can be employed for both dies.

As shown in FIG. 2A, the die 120 may include substrate 121, metallization layers 122, metal pads/routings 123, vias 124, and bumps 125. In some embodiments, the metal pads/routings 123 can be made of a conductive material, such as aluminum, copper, tungsten, other suitable conductive materials, or combinations thereof. The RC extraction tool 310 (see FIG. 1H) can create a virtual design 110′ (e.g., virtual mirrored bump pattern 115′, virtual metal fill pattern 113′) for extraction purposes, thereby eliminating the need to have the actual design of the die 110.

As shown in FIG. 2B, the virtual coupling capacitance extraction in the 3DIC structure 100 can be summarized by using the design of die 120, the RC techfile of die 110, and the RC techfile of die 120, in which the design of die 120 can be derived from the block 221b corresponding to the block 221 (see FIG. 1F) and the virtual coupling capacitance extraction in the 3DIC structure 100 can be derived from the block 222b corresponding to the block 222 (see FIG. 1F) . . . . Specifically, the design of the die 120 represents the specific structure, geometry, and characteristics of die 120. It forms the basis of the analysis for modeling the behavior of the die 120. The RC techfile of the die 120 may include detailed information about the resistive and capacitive properties of the interconnects and active device layers within the die 120. By RC extraction, we can know how signals will propagate within the die 120. The RC techfile of the die 120 may include detailed information about the die 110. This techfile, however, characterizes a virtual design 110′ and includes electrical parameters of process to compute the coupling capacitance between dies 110 and 120. The design of die 120, the RC techfile of die 110, and the RC techfile of die 120 can form a set of inputs allowing the system to simulate, analyze, and characterize the coupling capacitance between the dies 110 and 120 within the 3DIC structure 100. The information is used to generate a model of the interaction between the dies 110 and 120, including the effects of capacitance, which can then be used in further analysis and fabrication processes.

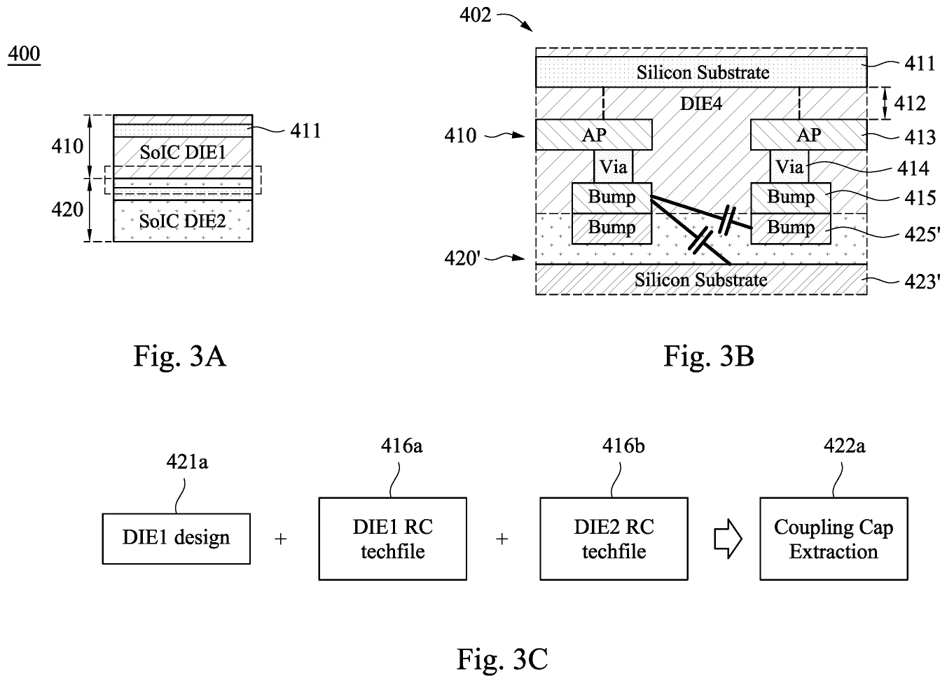

Reference is made to FIGS. 3A-3C. FIG. 3A illustrates a schematic view of a 3DIC structure 400, including multiple dies (e.g., dies 410, 420), in accordance with some embodiments of the present disclosure. FIG. 3B illustrates a schematic diagram of a cross coupling model 402 of the 3DIC structure 400 as shown in FIG. 3A in accordance with some embodiments of the present disclosure, in which the cross coupling model 402 includes a single die 410, a virtual mirrored bump pattern 425′, and a virtual ground plane pattern 423′ with an impedance mesh. FIG. 3C illustrates a block diagram of a system for analyzing a virtual coupling capacitance extraction on a die of a 3DIC structure 400 as shown in FIG. 3B in accordance with some embodiments of the present disclosure. The structure and function of a substrate 411, metallization layers 412, metal pads/routings 413, vias 414, and bumps 415 in the die 410 of the 3DIC structure 400 are substantially the same as the substrate 111, the metallization layers 112, the metal pads/routings 113, the vias 114, and the bumps 115 in the die 110 of the 3DIC structure 100 shown in FIG. 1B, and the related detailed descriptions may refer to the foregoing paragraphs, and are not described again herein.

As shown in FIG. 3A, the die 410 and the die 420 are combined together, with a front side of the die 410 bonded to a back side of the die 420. When the user is focusing on designing the die 410, a virtual design 420′ of die 420 can be part of the process. This virtual design 420′ may include specific components such as a virtual mirrored bump pattern 425′ and a virtual ground plane pattern 423′ (which might represent a silicon substrate) as shown in FIG. 3B. The method used to design die 410 is similar to the method used for designing the die 110 (see FIGS. 1A-1K). This suggests that the same principles, tools, and techniques can be applied, whether the user is working on the die 410 or the die 110. Although the design methodology might be the same, there are distinctions in the virtual designs of different dies (e.g., dies 110, 410). Specifically, in the virtual design of the die 420, the virtual ground plane pattern 423′ is used instead of the virtual metal fill pattern 123′ that is used in the virtual design 120′ of the die 120. Therefore, the present disclosure can use a consistent design methodology across different dies, which in turn leads to efficiency in the design process. In addition, the specific components in the virtual designs, such as virtual mirrored bump patterns 425′ or virtual ground planes 423′, allow for customization to suit the needs of individual dies. Furthermore, the described design approach can support the integration of two different dies, enabling the creation of complex systems where different dies perform different functions. Therefore, the present disclosure can provide a flexible and consistent methodology for designing semiconductor dies, accommodating the needs of different dies.

As shown in FIG. 3C, the virtual coupling capacitance extraction in the 3DIC structure 400 can be summarized by using the design of die 410, the RC techfile of die 410, and the RC techfile of die 420. In some embodiments, the design of the die 410 can be derived from the block 421a corresponding to the block 221 (see FIG. 1F), the RC techfile of the die 410 can be derived from the block 416a corresponding to the block 216 (see FIG. 1F), the RC techfile of the die 420 can be derived from the block 416b corresponding to the block 216 (see FIG. 1F), and the virtual coupling capacitance extraction in the 3DIC structure 400 can be derived from the block 422a corresponding to the block 222 (see FIG. 1F). Specifically, the design of the die 410 represents the specific structure, geometry, and characteristics of die 410. It forms the basis of the analysis for modeling the behavior of the die 410. The RC techfile of the die 410 may include detailed information about the resistive and capacitive properties of the interconnects and active device layers within the die 410. By RC extraction, we can know how signals will propagate within the die 410. The RC techfile of the die 420 may include detailed information about the die 420. This techfile, however, characterizes a virtual design 420′ and includes electrical parameters of process to compute the coupling capacitance between dies 410 and 420. The design of die 410, the RC techfile of die 410, and the RC techfile of die 420 can form a set of inputs allowing the system to simulate, analyze, and characterize the coupling capacitance between the dies 410 and 420 within the 3DIC structure 400. The information is used to generate a model of the interaction between the dies 410 and 420, including the effects of capacitance, which can then be used in further analysis and fabrication processes.

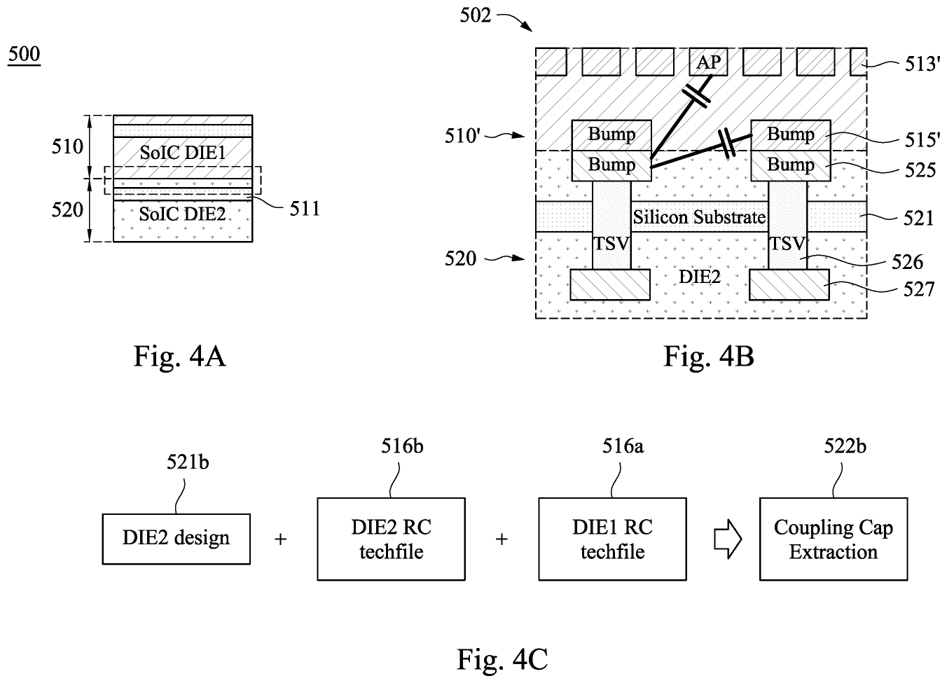

Reference is made to FIGS. 4A-4C. FIG. 4A illustrates a schematic view of a 3DIC structure 500, including multiple dies (e.g., dies 510, 520), in accordance with some embodiments of the present disclosure. FIG. 4B illustrates a schematic diagram of a cross coupling model 502 of the 3DIC structure 500 as shown in FIG. 4A in accordance with some embodiments of the present disclosure, in which the cross coupling model 502 includes a single die 520, a virtual mirrored bump pattern 515′, and a virtual metal fill pattern 513′ with an impedance mesh. FIG. 4C illustrates a block diagram of a system for analyzing a virtual coupling capacitance extraction on a die of a 3DIC structure as shown in FIG. 4B in accordance with some embodiments of the present disclosure. The die 520 may include a substrate 521 (e.g., silicon substrate), bumps 525 and metal layer 527 at opposite side of the substrate 521, and though silicon vias (TSV) 526 connecting the bumps 525 to the metal layer 527.

As shown in FIGS. 4A and 4B, the die 510 and the die 520 are combined together, with a front side of the die 510 bonded to a back side of the die 520. When the user is focusing on designing the die 520, a virtual design 510′ of die 510 can be part of the process. This virtual design 510′ may include specific components such as a virtual mirrored bump pattern 515′ and a virtual metal fill pattern 513′ as shown in FIG. 4B. The method used to design die 520 is similar to the method used for designing the die 110 (see FIGS. 1A-1K). This suggests that the same principles, tools, and techniques can be applied, whether the user is working on the die 520 or the die 110. Although the design methodology might be the same, there are distinctions in the virtual designs of different dies (e.g., dies 110, 520). Therefore, the present disclosure can use a consistent design methodology across different dies, which in turn leads to efficiency in the design process. In addition, the specific components in the virtual designs, such as virtual mirrored bump pattern 515′ or virtual metal fill pattern 523′, allow for customization to suit the needs of individual dies. Furthermore, the described design approach can support the integration of two different dies, enabling the creation of complex systems where different dies perform different functions. Therefore, the present disclosure can provide a flexible and consistent methodology for designing semiconductor dies, accommodating the needs of different dies.

As shown in FIG. 4C, the virtual coupling capacitance extraction in the 3DIC structure 500 can be summarized by using the design of die 520, the RC techfile of die 510, and the RC techfile of die 520. In some embodiments, the design of the die 520 can be derived from the block 521b corresponding to the block 221 (see FIG. 1F), the RC techfile of the die 520 can be derived from the block 516b corresponding to the block 216 (see FIG. 1F), the RC techfile of the die 510 can be derived from the block 516a corresponding to the block 216 (see FIG. 1F), and the virtual coupling capacitance extraction in the 3DIC structure 500 can be derived from the block 522b corresponding to the block 222 (see FIG. 1F). Specifically, the design of the die 520 represents the specific structure, geometry, and characteristics of die 520. It forms the basis of the analysis for modeling the behavior of the die 520. The RC techfile of the die 520 may include detailed information about the resistive and capacitive properties of the interconnects and active device layers within the die 520. By RC extraction, we can know how signals will propagate within the die 520. The RC techfile of the die 510 may include detailed information about the die 510. This techfile, however, characterizes a virtual design 510′ and includes electrical parameters of process to compute the coupling capacitance between dies 510 and 520. The design of die 520, the RC techfile of die 510, and the RC techfile of die 520 can form a set of inputs allowing the system to simulate, analyze, and characterize the coupling capacitance between the dies 510 and 520 within the 3DIC structure 500. The information is used to generate a model of the interaction between the dies 510 and 520, including the effects of capacitance, which can then be used in further analysis and fabrication processes.

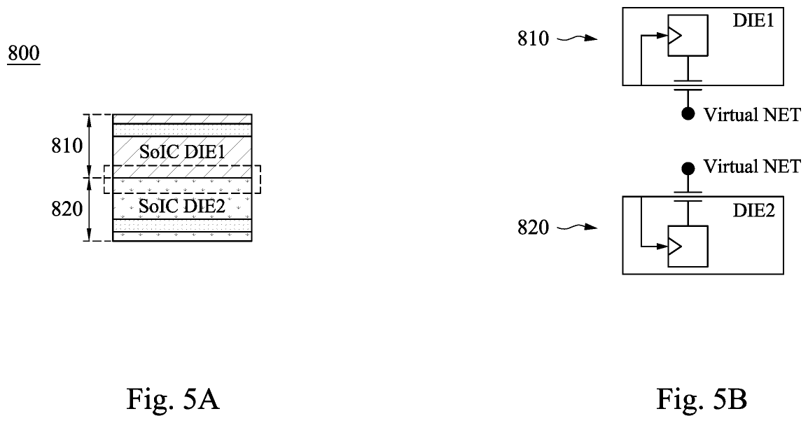

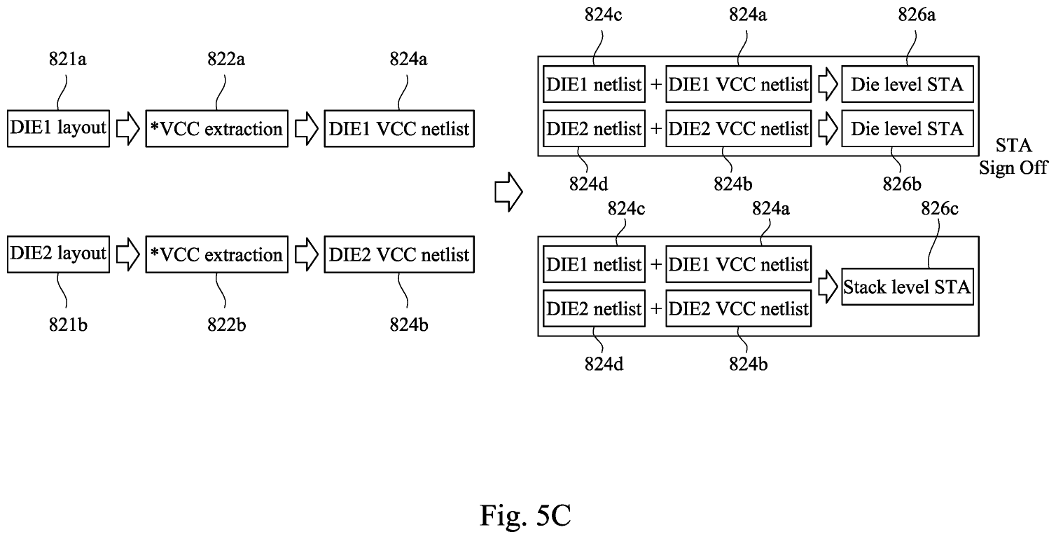

Reference is made to FIGS. 5A-5C. FIG. 5A illustrates a schematic view of a 3DIC structure 800, including multiple dies, in accordance with some embodiments of the present disclosure. FIG. 5B illustrates a schematic diagram of cross coupling models of the 3DIC structure 800 with virtual nets in accordance with some embodiments of the present disclosure. FIG. 5B illustrates a block diagram of a system for designing and analyzing an IC product of a 3DIC structure 800 in accordance with some embodiments of the present disclosure. The 3DIC structure 800 can include an integration of the die 810 and the die 820. The die 810 can adopt a first one of the dies as shown in FIGS. 1A, 3A, and 4A, and the die 820 can adopt a second one of the dies as shown in FIGS. 1A, 3A, and 4A.

In FIG. 5C, the user can initiate the design of the die 810 by defining its primary function and purpose and develop the circuit designs, structures, and geometries within the die 810. A netlist of the die 810 is then created. This netlist may include the connections, components, and relationships within the die 810, acting as a schematic representation of the layout of the die 810. From the layout of die 810 using the methods illustrated in FIGS. 1A-1K, the user can obtain virtual coupling capacitance extraction (i.e., or virtual cross-die coupling extraction (VCC)) extraction based on the die 810, which represents the coupling effects between die 810 and the neighboring die 820. The virtual coupling capacitance extraction can be translated into a virtual netlist, on an imaginary side, for further processing, and the virtual netlist is a schematic representation of the virtual coupling capacitance extraction for the die 810. Subsequently, by utilizing the netlist of die 810 and the virtual coupling capacitance netlist of the die 810, a die-level analysis of the timing characteristics (e.g., die-level static timing analysis (die-level STA)) within the die 810 can be obtained.

Similarly, the user can initiate the design of the die 820 by defining its primary function and purpose and develop the circuit designs, structures, and geometries within the die 820. A netlist of the die 820 is then created. This netlist may include the connections, components, and relationships within the die 820, acting as a schematic representation of the layout of the die 820. From the layout of die 820 using the methods illustrated in FIGS. 1A-1K, the user can obtain virtual coupling capacitance extraction based on the die 820, which represents the coupling effects between die 820 and the neighboring die 810. The virtual coupling capacitance extraction can be translated into a virtual netlist, on an imaginary side, for further processing, and the virtual netlist is a schematic representation of the virtual coupling capacitance extraction for the die 820. Subsequently, by utilizing the netlist of die 820 and the virtual coupling capacitance netlist of the die 820, a die-level analysis of the timing characteristics (e.g., die-level static timing analysis within the die 820 can be obtained.

Alternatively, by utilizing the netlists of the dies 810 and 820 and the virtual coupling capacitance netlist of the dies 810 and 820, a stack-level analysis of the timing characteristics (e.g., die-level static timing analysis within the semiconductor structure 800 can be obtained. Specifically, a combination of various netlists and virtual coupling capacitance netlists in the semiconductor structure 800 constitutes a part of the design and analysis process. The netlists of the dies 810 and 820 can be merged to ensure that the physical and virtual connections can be mapped. The virtual cross-die coupling netlists of dies 810 and 820 can be incorporated. The combined architecture, embracing both physical layouts and virtual interactions, forms a unified model of the semiconductor structure 800. With the unified model in place, a detailed stack-level static timing analysis can be performed to assess the timing characteristics across the stack. Therefore, the process of combining components (e.g., netlist and virtual coupling capacitance netlists of dies 810 and 820) for stack-level static timing analysis can integrate various facets of physical design and virtual interactions into a whole, allowing for a further analysis of the semiconductor structure 800.

In some embodiments, the design of the dies 810 and 820 can be derived from the blocks 821a and 821b corresponding to the block 221 (see FIG. 1F), the virtual coupling capacitance extractions of the dies 810 and 820 can be derived from the blocks 822a and 822b corresponding to the block 222 (see FIG. 1F), the virtual coupling capacitance netlists of the dies 810 and 820 can be derived from the blocks 824a and 824b corresponding to the block 224 (see FIG. 1F), the netlist of the dies 810 and 820 can be derived from the blocks 824c and 824d corresponding to the block 224 (see FIG. 1F), and the die-level static timing analysis and the stack-level static timing analysis of the dies 810 and 820 can be derived from the blocks 826a, 826b, and 826c corresponding to the block 226 (see FIG. 1F).

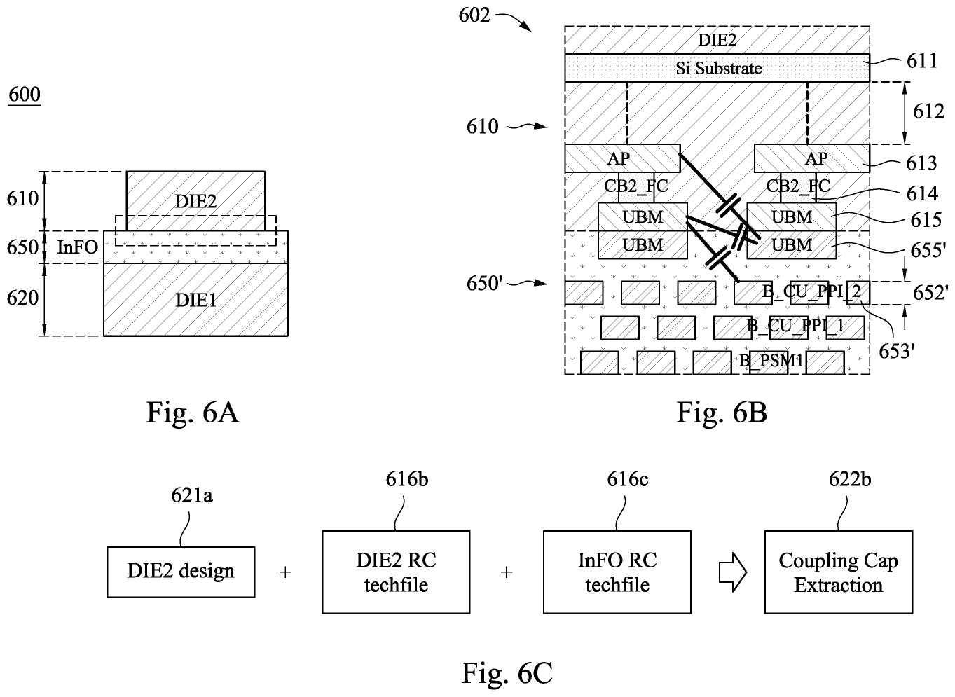

Reference is made to FIGS. 6A-6C. FIG. 6A illustrates a schematic view of a semiconductor structure 600, including multiple dies 610, 620, and an integrated fan-out (InFO) structure 650 between the dies 610 and 620, in accordance with some embodiments of the present disclosure. FIG. 6B illustrates a schematic diagram of a cross coupling model 602 of the semiconductor structure 600 as shown in FIG. 6A in accordance with some embodiments of the present disclosure, in which the 602 cross coupling model includes a single die 610, a virtual mirrored under bump metallurgy (UBM) pattern 655′, and a virtual metal fill pattern 653′ with an impedance mesh. FIG. 6C illustrates a block diagram of a system for analyzing a virtual coupling capacitance extraction on the die 610 of the semiconductor structure 600 as shown in FIG. 6B in accordance with some embodiments of the present disclosure. The structure and function of a substrate 611, metallization layers 612, metal pads/routings 613, vias 614, and bumps 615 in the die 610 of the semiconductor structure 600 are substantially the same as the substrate 111, the metallization layers 112, the metal pads/routings 113, the vias 114, and the bumps 115 in the die 110 of the 3DIC structure 100 shown in FIG. 1B, and the related detailed descriptions may refer to the foregoing paragraphs, and are not described again herein. In some embodiments, the bump 115 can be interchangeable referred to as under bump metallurgy (UBM).

As shown in FIGS. 6A and 6B, the InFO Structure 650 is a wafer-level packaging where chips are embedded into a mold compound (not shown). The InFO structure 650 can physically join the dies 610 and 620 through molded interposers that contain the redistribution layers (RDLs) including metal layers, the metal layer can be corresponding to the virtual metal fill pattern 653′ of the virtual redistribution layer 652′. The redistribution layers can facilitate the re-routing of signals from the tight bump pitch on the dies (e.g., dies 610, 620) to a more relaxed pitch suitable for connection to other components or another die (e.g., die 620). The redistribution layers can include the traces and spaces that electrically interconnect the dies 610 and 620, while the insulating mold compound isolates the traces. In some embodiments, the UMB in the InFO structure 650 can form reliable connections between the die's pads and the solder bumps, which ultimately facilitate interconnection with other components. The UBM may include of multiple layers of different metals, such as copper, nickel, gold, or other suitable materials. In some embodiments, the UBM can act as a barrier to prevent intermetallic compounds from forming between, such as the solder and the aluminum pad on the die. The UBM is part of the process of connecting the dies 610 and 620 within the package, allowing for the integration and fan-out of connections.

When the user is focusing on designing the die 610, a virtual design 650′ of the UMB in the InFO structure 650 can be part of the process. This virtual design 650′ may include specific components such as a virtual mirrored UBM pattern 655′ and a virtual metal fill pattern 653′ corresponding to the metal layers in the redistribution layer 652 as shown in FIG. 6B. In some embodiments, the user can consider including more routing layers of the virtual metal fill pattern 653′ to build the coupling capacitance model 602. The method used to design die 610 is similar to the method used for designing the die 110 (see FIGS. 1A-1K). This suggests that the same principles, tools, and techniques can be applied, whether the user is working on the die 610 or the die 110. Although the design methodology might be the same, there are distinctions in the virtual designs of different dies (e.g., dies 110, 610). Specifically, in the virtual design 650′ of the InFO structure 650, the virtual metal fill pattern 653′ is used instead of the virtual metal fill pattern 123′ that is used in the virtual design 120′ of the die 120. Therefore, the present disclosure can use a consistent design methodology across different dies, which in turn leads to efficiency in the design process. In addition, the specific components in the virtual designs, such as virtual mirrored UBM pattern 655′ or virtual ground planes 653′, allow for customization to suit the needs of individual dies. Furthermore, the described design approach can support the integration of two different dies with the InFO structure, enabling the creation of complex systems where different dies perform different functions. Therefore, the present disclosure can provide a flexible and consistent methodology for designing semiconductor dies, accommodating the needs of different dies with the InFO structure.

As shown in FIG. 6C, the virtual coupling capacitance extraction in the semiconductor structure 600 can be summarized by using the design of the die 610, the RC techfile of die 610, and the RC techfile of the InFO structure 650. In some embodiments, the design of the die 610 can be derived from the block 621a corresponding to the block 221 (see FIG. 1F), the RC techfile of the die 610 can be derived from the block 616a corresponding to the block 216 (see FIG. 1F), the RC techfile of the InFO structure 650 can be derived from the block 616c corresponding to the block 216 (see FIG. 1F), and the virtual coupling capacitance extraction in the 3DIC structure 600 can be derived from the block 622a corresponding to the block 222 (see FIG. 1F). Specifically, the design of the die 610 represents the specific structure, geometry, and characteristics of die 610. It forms the basis of the analysis for modeling the behavior of the die 610. The RC techfile of the die 610 may include detailed information about the resistive and capacitive properties of the interconnects and active device layers within the die 610. By RC extraction, we can know how signals will propagate within the die 610. The RC techfile of the InFO structure 650 may include detailed information about the InFO structure 650. This techfile, however, characterizes a virtual design 650′ and includes electrical parameters of process to compute the coupling capacitance between the die 610 and the InFO structure 650. The design of die 610, the RC techfile of die 610, and the RC techfile of the InFO structure 650 can form a set of inputs allowing the system to simulate, analyze, and characterize the coupling capacitance between the die 610 and the InFO structure 650 within the semiconductor structure 600. The information is used to generate a model of the interaction between the die 610 and the InFO structure 650, including the effects of capacitance, which can then be used in further analysis and fabrication processes.

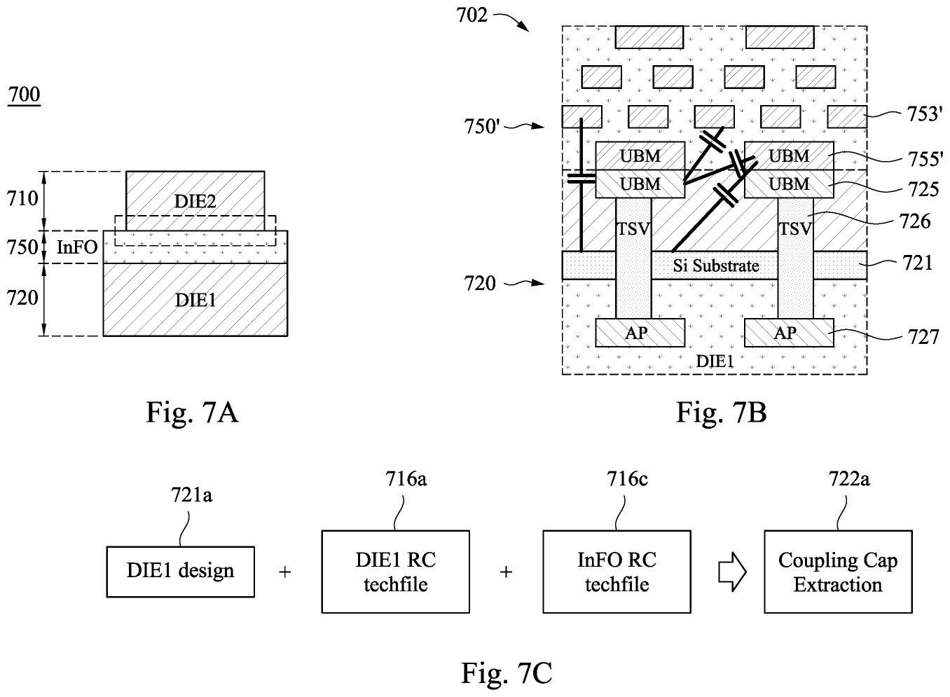

Reference is made to FIGS. 7A-7C. FIG. 7A illustrates a schematic view of a semiconductor structure 700, including multiple dies (e.g., dies 710, 720) and an InFO structure 750 between the dies 710 and 720, in accordance with some embodiments of the present disclosure. FIG. 7B illustrates a schematic diagram of a cross coupling model 702 of the semiconductor structure 700 as shown in FIG. 7A in accordance with some embodiments of the present disclosure, in which the cross coupling model 702 includes a single die 720, a virtual mirrored UBM pattern 755′, and a virtual metal fill pattern 753′ with an impedance mesh. FIG. 7C illustrates a block diagram of a system for analyzing a virtual coupling capacitance extraction on the die 720 of the semiconductor structure 700 as shown in FIG. 7B in accordance with some embodiments of the present disclosure.

As shown in FIGS. 7A and 7B, the InFO structure 750 can physically join the dies 710 and 720 through molded interposers that contain the redistribution layers (RDLs) including metal layers, the metal layer can be corresponding to the virtual metal fill pattern 753′. In some embodiments, the die 720 can combined to the InFO structure 750, with a back side of the die 720. As shown in FIG. 7B, the die 720 may include a substrate 721 (e.g., silicon substrate), bumps 725 and metal layer 727 at opposite side of the substrate 721, and though silicon vias (TSV) 726 connecting the bumps 725 to the metal layer 727.

When the user is focusing on designing the die 720, a virtual design 750′ of the InFO structure 750 can be part of the process. This virtual design 750′ may include specific components such as a virtual mirrored UBM pattern 755′ and a virtual metal fill pattern 753′ as shown in FIG. 7B. The method used to design die 720 is similar to the method used for designing the die 110 (see FIGS. 1A-1K). This suggests that the same principles, tools, and techniques can be applied, whether the user is working on the die 720 or the die 110. Although the design methodology might be the same, there are distinctions in the virtual designs of different dies (e.g., dies 110, 720). Therefore, the present disclosure can use a consistent design methodology across different dies, which in turn leads to efficiency in the design process. In addition, the specific components in the virtual designs, such as virtual mirrored UBM pattern 755′ or virtual metal fill pattern 753′, allow for customization to suit the needs of individual dies. Furthermore, the described design approach can support the integration of two different dies with the InFO structure, enabling the creation of complex systems where different dies perform different functions. Therefore, the present disclosure can provide a flexible and consistent methodology for designing semiconductor dies, accommodating the needs of different dies with the InFO structure.

As shown in FIG. 7C, the virtual coupling capacitance extraction in the semiconductor structure 700 can be summarized by using the design of die 720, the RC techfile of die 720, and the RC techfile of the InFO structure 750. In some embodiments, the design of the die 720 can be derived from the block 721b corresponding to the block 221 (see FIG. 1F), the RC techfile of the die 720 can be derived from the block 716b corresponding to the block 216 (see FIG. 1F), the RC techfile of the InFO structure 750 can be derived from the block 716c corresponding to the block 216 (see FIG. 1F), and the virtual coupling capacitance extraction in the 3DIC structure 700 can be derived from the block 722b corresponding to the block 222 (see FIG. 1F). Specifically, the design of the die 720 represents the specific structure, geometry, and characteristics of die 720. It forms the basis of the analysis for modeling the behavior of the die 720. The RC techfile of the die 720 may include detailed information about the resistive and capacitive properties of the interconnects and active device layers within the die 720. By RC extraction, we can know how signals will propagate within the die 720. The RC techfile of the InFO structure 750 may include detailed information about the InFO structure 750. This techfile, however, characterizes a virtual design 750′ and includes electrical parameters of process to compute the coupling capacitance between the die 720 and the InFO structure 750. The design of die 720, the RC techfile of die 720, and the RC techfile of the InFO structure 750 can form a set of inputs allowing the system to simulate, analyze, and characterize the coupling capacitance between the die 720 and the InFO structure 750 within the semiconductor structure 700. The information is used to generate a model of the interaction between the die 720 and the RC techfile of die 720, including the effects of capacitance, which can then be used in further analysis and fabrication processes.

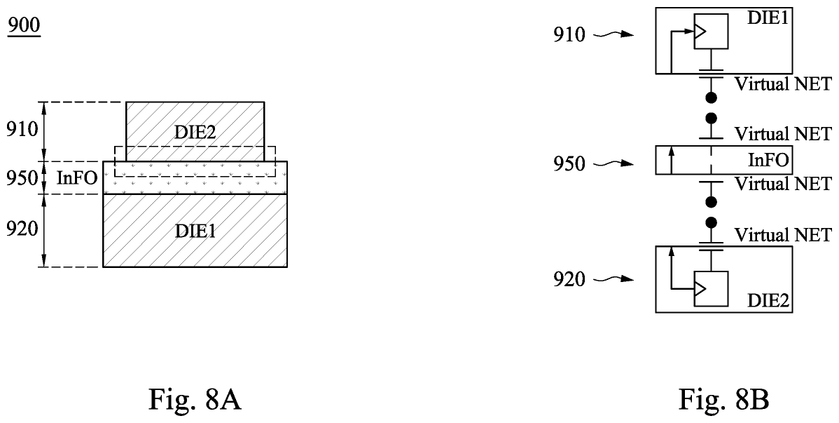

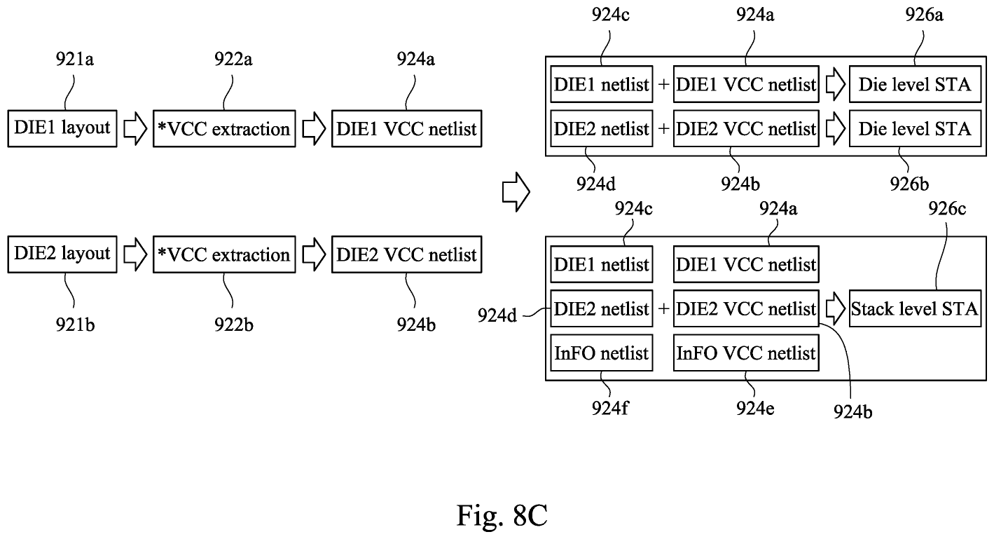

Reference is made to FIGS. 8A-8C. FIG. 8A illustrates a schematic view of a semiconductor structure 900, including multiple dies 910, 920, and an InFO structure 950 between the dies 910 and 920, in accordance with some embodiments of the present disclosure. FIG. 8B illustrates a schematic diagram of cross coupling models of the semiconductor structure 900 with virtual nets in accordance with some embodiments of the present disclosure. FIG. 8C illustrates a block diagram of a system for designing and analyzing an IC product including the InFO structure 950 in accordance with some embodiments of the present disclosure. The semiconductor structure 900 can include an integration of the die 910 and the die 920. The die 910 can adopt a first one of the dies as shown in FIGS. 1A, 3A, 4A, 6A, and 7A and the die 920 can adopt a second one of the dies as shown in FIGS. 1A, 3A, 4A, 6A, and 7A. The structure and function of the InFO structure 950 is substantially the same as the InFO structures 650, 750 shown in FIGS. 6A and 7A, and the related detailed descriptions may refer to the foregoing paragraphs, and are not described again herein.

In FIG. 8C, the user can initiate the design of the die 910 by defining its primary function and purpose and develop the circuit designs, structures, and geometries within the die 910. A netlist of the die 910 is then created. This netlist may include the connections, components, and relationships within the die 910, acting as a schematic representation of the layout of the die 910. From the layout of die 910 using the methods illustrated in FIGS. 1A-1K, the user can obtain virtual coupling capacitance extraction (i.e., or virtual cross-die coupling extraction (VCC)) extraction based on the die 910, which represents the coupling effects between die 910 and the neighboring InFO structure 950. The virtual coupling capacitance extraction can be translated into a virtual netlist, on an imaginary side, for further processing, and the virtual netlist is a schematic representation of the virtual coupling capacitance extraction for the die 910. Subsequently, by utilizing the netlist of die 910 and the virtual coupling capacitance netlist of the die 910, a die-level analysis of the timing characteristics (e.g., die-level static timing analysis (die-level STA)) within the die 910 can be obtained.

Similarly, the user can initiate the design of the die 920 by defining its primary function and purpose and develop the circuit designs, structures, and geometries within the die 920. A netlist of the die 920 is then created. This netlist may include the connections, components, and relationships within the die 920, acting as a schematic representation of the layout of the die 920. From the layout of die 920 using the methods illustrated in FIGS. 1A-1K, the user can obtain virtual coupling capacitance extraction based on the die 920, which represents the coupling effects between die 920 and the neighboring InFO structure 950. The virtual coupling capacitance extraction can be translated into a virtual netlist, on an imaginary side, for further processing, and the virtual netlist is a schematic representation of the virtual coupling capacitance extraction for the die 920. Subsequently, by utilizing the netlist of the die 920 and the virtual coupling capacitance netlist of the die 920, a die-level analysis of the timing characteristics (e.g., die-level static timing analysis within the die 920 can be obtained.

Alternatively, by utilizing the netlists of the dies 910 and 920 and the virtual coupling capacitance netlist of the dies 910 and 920, a stack-level analysis of the timing characteristics (e.g., die-level static timing analysis within the semiconductor structure 900 can be obtained. Specifically, a combination of various netlists and virtual coupling capacitance netlists in the semiconductor structure 900 constitutes a part of the design and analysis process. The netlists of the dies 910 and 920, along with the netlists of the InFO structure 950 on opposite sides thereof, can be merged to ensure that the physical and virtual connections can be mapped. The virtual cross-die coupling netlists of dies 910 and 920, along with the netlists of the InFO structure 950 on opposite sides thereof, can be incorporated. The combined architecture, embracing both physical layouts and virtual interactions, forms a unified model of the semiconductor structure 900. With the unified model in place, a detailed stack-level static timing analysis can be performed to assess the timing characteristics across the stack. Therefore, the process of combining components (e.g., netlist and virtual coupling capacitance netlists of dies 910 and 920 and the InFO structure 950) for stack-level static timing analysis can integrate various facets of physical design and virtual interactions into a whole, allowing for a further analysis of the semiconductor structure 900.

In some embodiments, the design of the dies 910 and 920 can be derived from the blocks 921a and 921b corresponding to the block 221 (see FIG. 1F), the virtual coupling capacitance extractions of the dies 910 and 920 can be derived from the blocks 922a and 922b corresponding to the block 222 (see FIG. 1F), the virtual coupling capacitance netlists of the dies 910 and 920 and the InFO structure 950 can be derived from the blocks 924a, 924b, and 924e corresponding to the block 224 (see FIG. 1F), the netlists of the dies 910 and 920 and the InFO structure 950 can be derived from the blocks 924c, 924d, and 924f corresponding to the block 224 (see FIG. 1F), and the die-level static timing analysis and the stack-level static timing analysis of the dies 910 and 920 can be derived from the blocks 926a, 926b, and 926c corresponding to the block 226 (see FIG. 1F).

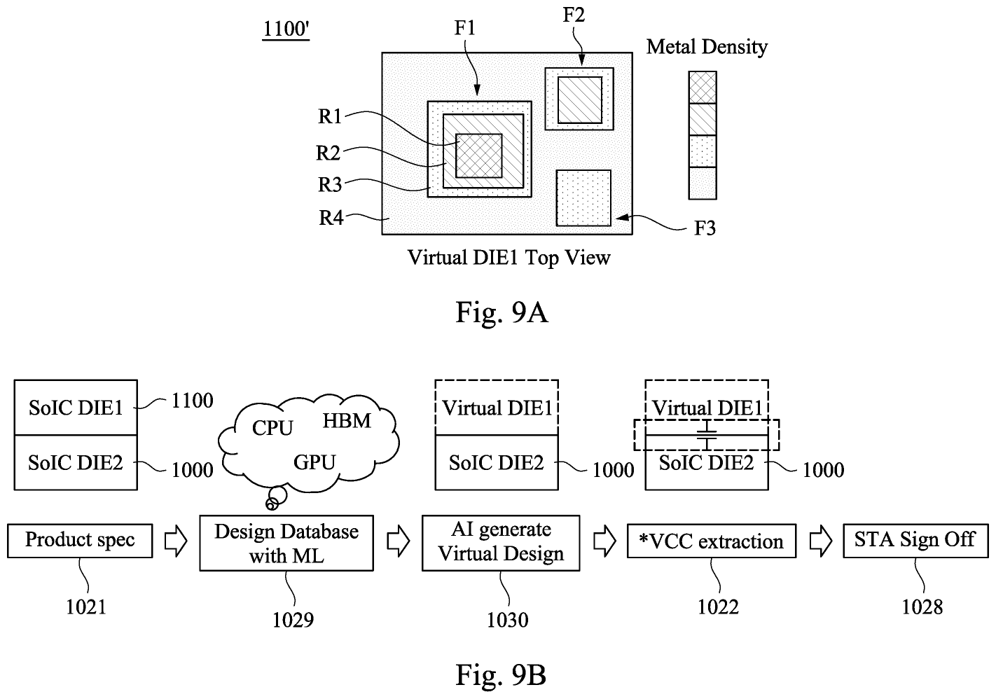

Reference is made to FIG. 9A. FIG. 9A illustrates a top view of a virtual die image of a die 1100′ having regions with different metal densities in accordance with some embodiments of the present disclosure. Specifically, in a 3DIC structure comprising a multi-die design, components might originate from diverse teams or even separate companies. These distinct elements can be assembled through a packaging process, allowing for the creation of a system. Before reaching the level of physical integration through stacking, users have the can generate virtual designs that can assess cross-die effects, which can provide an information about the interactions between dies. Utilizing a database (e.g., design house database), users can employ artificial intelligence (AI) and machine learning (ML) techniques to formulate metal routing density for various types of designs. These include but are not limited to GPU (Graphics Processing Unit), CPU (Central Processing Unit), and HBM (High Bandwidth Memory) configurations. The AI-driven methodology ensures that the design can meet the needs and characteristics of the particular components, enhancing performance and efficiency. In FIG. 9A, a virtual design (e.g., the virtual metal fill pattern 123′ of the 3DIC as shown in FIG. 1B) can be the generated from the presence of multiple die footprints, such as F1, F2, and F3, each corresponding to different design forms (e.g., GPU, CPU, and HBM). Consequently, the virtual metal fill pattern generated on the die 1100′ may need to exhibit variations in density across the range of the different footprints F1, F2, and F3. The ability to manipulate and customize these densities within distinct regions enables a control over the design, ensuring compatibility within the 3DIC structure.

In some embodiments, the utilization of artificial intelligence (AI) and machine learning (ML) can be utilized in the process of creating a virtual design for the die 1100′, such that the distinct footprints F1, F2, and F3 corresponding to various dies incorporated within the design (e.g., GPU, CPU, and HBM) can be identified. By identifying these footprint forms, the virtual metal fill patterns can be created to meet specific density ranges that align with the characteristics of the corresponding dies. Therefore, the application of AI and ML not only ensures a customized approach to each footprint but also offers the flexibility to construct distinct virtual metal fill patterns within a single footprint on die 1100′. This adaptability arises from the differences in the functions of the circuits used within that footprint, which can range from such as logic areas to peripheral memory regions.

Regarding to the design within the footprint F1 on the die 1100′, virtual metal fill patterns in different regions may be with different density characteristics to represent the functionalities of the corresponding areas. For example, the design can be segmented into three regions: R1, R2, R3, and R4 as shown in FIG. 9A. The first region R1 could represent such as a logical area within the footprint F1 of the die 1100′. Moving outward from the first region R1, the second region R2, could correspond to, such as a peripheral memory region. The third region R3 may be associated with, such as a power domain of the die 1100′. In some embodiments, the die 1100′ may have a fourth region R4 laterally surrounds the footprints F1, F2, and F3. In some embodiments, the virtual metal fill pattern in the first region R1 can have a greater metal routing density than in the second region R2, the virtual metal fill pattern in the second region R2 can have a greater metal routing density than in the third region R3, and the virtual metal fill pattern in the second region R3 can have a greater metal routing density than in the third region R4. The differentiation in densities between these regions R1, R2, R3, and R4 can mirror the architecture of the die, where different sections have varying requirements for connectivity, processing speed, and energy management. By way of example and not limitation, the metal routing density in the region R1 may be in a range from about 65-85%, such as about 65, 70, 75, 80, or 85%. The metal routing density in the region R2 may be in a range from about 45-65%, such as about 45, 50, 55, 60, or 65%. The metal routing density in the region R3 may be in a range from about 25-45%, such as 25, 30, 35, 40, or 45%. The metal routing density in the region R4 may be in a range from about 5-25%, such as 5, 10, 15, 20, or 25%.

Reference is made to FIG. 9B. FIG. 9B illustrates a process with block diagrams of a system for designing and analyzing an IC product in accordance with some embodiments of the present disclosure. At block 1021, the process can begin with the definition of the product specifications for the die 1000 and/or the die 1100. This preliminary phase may involve detailing the requirements, functional parameters, and performance criteria for the components involved, ensuring that all design decisions align with the objectives of the product. Subsequently, at block 1029, machine learning algorithms can be applied to classify the corresponding devices within different footprints as specific types, such as GPU, CPU, or HBM, which in turn enables a more targeted design approach by understanding the characteristics of each type. Subsequently, at block 1030, an AI technology can be used to create a virtual design on the die 1000. The AI algorithms can calculate the appropriate density ranges for the footprints of the different corresponding dies, which in turn allows for the construction of virtual metal fill patterns with varying densities. Subsequently, at block 1022, the virtual coupling capacitance extraction for the die 1000 can be obtained, in response to the analysis of the electromagnetic interactions between the various elements within the dies 1000 and the virtual design. Subsequently, at block 1028, the design can undergo a static timing analysis to assess whether the die 1000 can be a sign-off status and then manufactured in accordance with the established specifications. This analysis evaluates the timing behavior of the circuit, including delays and clock domains, ensuring that the design meets the timing requirements for successful fabrication. In some embodiments, the definition of the product specifications (e.g., layout or design) for the die 1000 can be derived from the block 1021 corresponding to the block 221 (see FIG. 1F), and the virtual coupling capacitance extractions of the die 1000 can be derived from the blocks 1022 corresponding to the block 222 (see FIG. 1F).

Therefore, based on the above discussions, it can be seen that the present disclosure offers advantages. It is understood, however, that other embodiments may offer additional advantages, and not all advantages are necessarily disclosed herein, and that no particular advantage is required for all embodiments. The present disclosure in various embodiments provides a virtual design on a die (or first die) in 3DIC structure for the RC extraction, thereby eliminating the need to have the actual design of another die (or second die) in the 3DIC structure. For example, by attaching the cross coupling capacitance to a virtual signal node resulted from the virtual design (e.g., virtual mirrored bump pattern, virtual metal fill pattern), the specific details of the second die can be abstracted away, which in turn reduces the extraction process's dependence on the actual characteristics of the second die, enabling more flexible and adaptable extraction results on the first die.

In some embodiments, a method includes accessing a layout of a first die, wherein the first die is of a three-dimensional integrated circuit (3DIC) structure; generating a virtual design based on the layout of the first die, a first resistance and capacitance (RC) technology file (techfile) of the first die, and a second RC techfile of a second die, wherein the second die is of the 3DIC structure; performing a virtual coupling capacitance extraction on the virtual design to form a virtual coupling capacitance netlist; performing an static timing analysis on the first die with the virtual coupling capacitance netlist. In some embodiments, the step of generating the virtual design is free from using a 3DIC stack topology including a layout of the second die. In some embodiments, the virtual design comprises a virtual mirrored bump pattern and a virtual metal fill pattern, and the virtual mirrored bump pattern and the virtual metal fill pattern act as a plurality of virtual signal nodes. In some embodiments, the method further includes prior to performing the static timing analysis, annotating the virtual coupling capacitance netlist by the virtual signal nodes. In some embodiments, the virtual mirrored bump pattern has circular top view profiles, and the virtual metal fill pattern has rectangular top view profiles. In some embodiments, the virtual design comprises a virtual mirrored bump pattern and a virtual silicon substrate ground plane, and the virtual mirrored bump pattern and the virtual silicon substrate ground plane act as a plurality of virtual signal nodes. In some embodiments, the first die is configured to be bonded to the second die through a front-side of the first die, and the first die comprises a plurality of bumps and a plurality of metal pads/routings, the bumps and the metal pads/routings act as a plurality of signal nodes of the virtual coupling capacitance netlist. In some embodiments, the first die is configured to be bonded to the second die through a back-side thereof, the first die comprises a metal layer, a bump, a substrate between the metal layer and the bump, and a through silicon via extending from the metal layer to the bump through the substrate, and the bumps act as a plurality of signal nodes of the virtual coupling capacitance netlist. In some embodiments, the method further includes prior to generating the virtual design, identifying a type of second die through a machine learning algorithm, the type of second die being of central processing unit (CPU), graphics processing unit (GPU), or high bandwidth memory (HBM). In some embodiments, the method further includes determining a metal routing density of the virtual design through an artificial intelligence model, in response to the identified type of the second die.

In some embodiments, a method includes accessing a first layout of a first die; generating a first virtual design based on the first layout of the first die, a first resistance and capacitance (RC) technology file (techfile) of the first die, and a second RC techfile of an integrated fan-out (InFO) structure; performing a first virtual coupling capacitance extraction on the first virtual design to form a first virtual coupling capacitance netlist; performing a first static timing analysis on the first die with the first virtual coupling capacitance netlist. In some embodiments, the first virtual design comprises a virtual mirrored under bump metallurgy (UBM) pattern and a first virtual redistribution layer including a first virtual metal fill pattern, the virtual mirrored UBM pattern and the first virtual metal fill pattern act as a plurality of first virtual signal nodes of the first virtual coupling capacitance netlist. In some embodiments, the first virtual design comprises a second virtual redistribution layer at different level height than the first virtual redistribution layer, the second virtual redistribution layer comprises a second virtual metal fill pattern, the second virtual metal fill pattern acts as a plurality of second virtual signal nodes of the first virtual coupling capacitance netlist. In some embodiments, the first virtual metal fill pattern comprises a plurality of metal lines, and a pitch of the metal lines is set to a minimum pitch established in a design rule of the InFO structure. In some embodiments, the method further includes accessing a second layout of a second die; generating a second virtual design based on the second design of the second die, the second RC techfile of the InFO structure, and a third RC techfile of the second die; performing a second virtual coupling capacitance extraction on the second virtual design to form a second virtual coupling capacitance netlist; performing a second static timing analysis on the second die with a second netlist of the second die, along with the second virtual coupling capacitance netlist.

In some embodiments, a system includes a capacitance extraction tool, a mesh generation engine, and a static timing analysis tool. The capacitance extraction tool generates a virtual design of a first die in a three-dimensional integrated circuit (3DIC) structure, in which the generating is based on a first resistance and capacitance (RC) technology file of the first die, and a second RC techfile of a second die, and a layout of the second die, the second die is of the 3DIC structure and configured to stack with the first die. The mesh generation engine generates a virtual coupling capacitance netlist in response to the virtual design. The static timing analysis tool performs a simulation based on the virtual coupling capacitance netlist to account for a cross coupling capacitance between the first die and the second die. In some embodiments, the virtual design generated by the capacitance extraction tool determines positions of virtual capacitance nodes of the virtual coupling capacitance netlist. In some embodiments, the virtual design generated by the capacitance extraction tool comprises virtual mirrored bump pattern and a virtual metal fill pattern. In some embodiments, the virtual design generated by the capacitance extraction tool comprises a virtual ground plane pattern. In some embodiments, the simulation associated with the cross coupling capacitance is free from using a layout of the second die.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
accessing a layout of a first die, wherein the first die is of a three-dimensional integrated circuit (3DIC) structure;
generating a virtual design based on the layout of the first die, a first resistance and capacitance (RC) technology file (techfile) of the first die, and a second RC techfile of a second die, wherein the second die is of the 3DIC structure;
performing a virtual coupling capacitance extraction on the virtual design to form a virtual coupling capacitance netlist; and
performing an static timing analysis on the first die with the virtual coupling capacitance netlist.

2. The method of claim 1, wherein the step of generating the virtual design is free from using a 3DIC stack topology including a layout of the second die.

3. The method of claim 1, wherein the virtual design comprises a virtual mirrored bump pattern and a virtual metal fill pattern, and the virtual mirrored bump pattern and the virtual metal fill pattern act as a plurality of virtual signal nodes.

4. The method of claim 3, further comprising:
prior to performing the static timing analysis, annotating the virtual coupling capacitance netlist by the virtual signal nodes.

5. The method of claim 3, wherein the virtual mirrored bump pattern has circular top view profiles, and the virtual metal fill pattern has rectangular top view profiles.

6. The method of claim 1, wherein the virtual design comprises a virtual mirrored bump pattern and a virtual silicon substrate ground plane, and the virtual mirrored bump pattern and the virtual silicon substrate ground plane act as a plurality of virtual signal nodes.

7. The method of claim 1, wherein the first die is configured to be bonded to the second die through a front-side of the first die, and the first die comprises a plurality of bumps and a plurality of metal pads/routings, the bumps and the metal pads/routings act as a plurality of signal nodes of the virtual coupling capacitance netlist.

8. The method of claim 1, wherein the first die is configured to be bonded to the second die through a back-side thereof, the first die comprises a metal layer, a bump, a substrate between the metal layer and the bump, and a through silicon via extending from the metal layer to the bump through the substrate, and the bumps act as a plurality of signal nodes of the virtual coupling capacitance netlist.

9. The method of claim 1, further comprising:
prior to generating the virtual design, identifying a type of second die through a machine learning algorithm, the type of second die being of central processing unit (CPU), graphics processing unit (GPU), or high bandwidth memory (HBM).

10. The method of claim 9, further comprising:
determining a metal routing density of the virtual design through an artificial intelligence model, in response to the identified type of the second die.

11. A method, comprising:
accessing a first layout of a first die;
generating a first virtual design based on the first layout of the first die, a first resistance and capacitance (RC) technology file (techfile) of the first die, and a second RC techfile of an integrated fan-out (InFO) structure;
performing a first virtual coupling capacitance extraction on the first virtual design to form a first virtual coupling capacitance netlist; and
performing a first static timing analysis on the first die with the first virtual coupling capacitance netlist.

12. The method of claim 11, wherein the first virtual design comprises a virtual mirrored under bump metallurgy (UBM) pattern and a first virtual redistribution layer including a first virtual metal fill pattern, the virtual mirrored UBM pattern and the first virtual metal fill pattern act as a plurality of first virtual signal nodes of the first virtual coupling capacitance netlist.

13. The method of claim 12, wherein the first virtual design comprises a second virtual redistribution layer at different level height than the first virtual redistribution layer, the second virtual redistribution layer comprises a second virtual metal fill pattern, the second virtual metal fill pattern acts as a plurality of second virtual signal nodes of the first virtual coupling capacitance netlist.

14. The method of claim 12, wherein the first virtual metal fill pattern comprises a plurality of metal lines, and a pitch of the metal lines is set to a minimum pitch established in a design rule of the InFO structure.

15. The method of claim 11, further comprising:
accessing a second layout of a second die;
generating a second virtual design based on the second design of the second die, the second RC techfile of the InFO structure, and a third RC techfile of the second die;
performing a second virtual coupling capacitance extraction on the second virtual design to form a second virtual coupling capacitance netlist; and
performing a second static timing analysis on the second die with a second netlist of the second die, along with the second virtual coupling capacitance netlist.

16. A system, comprising:
a capacitance extraction tool, generating a virtual design of a first die in a three-dimensional integrated circuit (3DIC) structure, wherein the generating is based on a first resistance and capacitance (RC) technology file of the first die, and a second RC techfile of a second die, and a layout of the second die, the second die is of the 3DIC structure and configured to stack with the first die;
a mesh generation engine, generating a virtual coupling capacitance netlist in response to the virtual design; and
a static timing analysis tool, performing a simulation based on the virtual coupling capacitance netlist to account for a cross coupling capacitance between the first die and the second die.

17. The system of claim 16, wherein the virtual design generated by the capacitance extraction tool determines positions of virtual capacitance nodes of the virtual coupling capacitance netlist.

18. The system of claim 16, wherein the virtual design generated by the capacitance extraction tool comprises virtual mirrored bump pattern and a virtual metal fill pattern.

19. The system of claim 16, wherein the virtual design generated by the capacitance extraction tool comprises a virtual ground plane pattern.

20. The system of claim 16, wherein the simulation associated with the cross coupling capacitance is free from using a layout of the second die.
